(19) United States
(12) Patent Application Publication
(10) Pub. No.: US 2004/0086098 A1
(43) Pub. Date: May 6, 2004

(54) Method and process to integrate prepaid PIN disbursement at retail point of sale (POS)

(76) Inventor: Michael Kent Craft, San Diego, CA (US)

Correspondence Address: MICHAEL K. CRAFT, 10345 AZUAGA ST., #75, SAN DIEGO, CA, 92129, US

(21) Appl. No.: 10/065,622

(22) Filed: Nov. 4, 2002

(51) Int. Cl. H04M 15/00

(52) U.S. Cl. 379/114.2

(57) ABSTRACT

The present invention provides a system and method for a prepaid service system to be integrated with retail POS programs.

### BACKGROUND OF INVENTION

Typically, prepaid services are offered to subscribers utilizing a prepaid calling card. Normally, the customer buys a calling card and must dial a special access number, usually a 1-800 number in the United States, followed by a PIN number and then the call number to complete an outgoing call. In electronic commerce the customer buys a prepaid commerce card that provides a PIN to be entered at a world wide website account where card is to be used “same-as-cash.” The typical prepaid card is generally not tied to a specific directory number or specific device. Furthermore, the prepaid card service generally does not support incoming calls or electronic commerce. Generally prepaid cards are considered a commodity. Typical prepaid card systems generally lack the ability to reuse or restock the card after purchase or PIN depletion. Since most prepaid cards are purchased at a point of sale terminal at a grocery store or other commercial, inventory is lost and new product must be replaced to stock the sales floor. Furthermore, the current retail POS programs generally lack the ability to dynamically assign a PIN when scanning a prepaid card at the point of sale. Likewise, lacking is the ability to keep the prepaid card for reuse; allowing the card to scanned multiple times, resulting with a new PIN each time. Thus, a heretofore-unaddressed need exists in the industry to address the aforementioned and/or other deficiencies and inadequacies.

### DETAILED DESCRIPTION

The present invention provides a system and method for a prepaid service system to be integrated with retail POS programs. Briefly described, in architecture, the system of the preferred embodiment can be implemented as follows. The system includes POS programs using logic for connecting to a network. Logic is used for requesting access realtime prepaid PIN databases or “buckets”. Logic also is provided for acquiring appropriate dynamically assigned prepaid PIN at point of purchase. The present invention can also be viewed as providing a prepaid service system. The method operates by (1) connecting to a network; (2) requesting access to realtime PIN-generating software; and (3) dynamically assigning PIN to corresponding SKU on the prepaid card. Other features and advantages of the present invention will become apparent to one with skill in the art upon examination of the following drawings and detailed description. It is intended that all such additional features and advantages be included herein within the scope of the present invention.

The foregoing description has been presented for purposes of illustration and description. It is not intended to be exhaustive or to limit the invention to the precise forms disclosed. Modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. Methods and system for facilitating integration of prepaid PIN disbursement services with retail POS software. By which retail POS system references additional computers to determine and assign appropriate PIN and thus printing appropriate PIN on customer receipt for use at retailer's private label World Wide Website. With this system, typical cards representing specific monetary denominations are assigned and printed with SKUs that match denomination printed on the cards. These SKUs provide access to specific PIN databases. The PIN databases are grouped into corresponding denominations “Buckets” in association with the SKUs' represented denominations. The appropriate PIN “bucket”sends PIN to POS to be printed on customer receipt for use as access key to services at retailer's private label World Wide Website.
